(19) United States
(12) Patent Application Publication
(10) Pub. No.: US 2011/0234799 A1
(43) Pub. Date: Sep. 29, 2011

(54) REAR-VIEWING SYSTEM, REAR-VIEWING DEVICE FOR VEHICLES AND A METHOD FOR DISPLAYING A STABLE IMAGE

(75) Inventor: Ralf MUELLER, Wernau (DE)

(73) Assignee: Sony Corporation, Tokyo (JP)

(21) Appl. No.: 13/021,138

(22) Filed: Feb. 4, 2011

(30) Foreign Application Priority Data
Mar. 24, 2010 (EP) 10003168.1

(51) Int. Cl. H04N 7/18

(52) U.S. Cl. 348/148; 348/E07.085

(57) ABSTRACT

A rear-viewing device and a rear-viewing system for vehicles comprise a camera configured to capture input images and a display configured to display output images based on the input images. The device and the system further comprises a vibration sensor configured to determine a vibration of the display and/or the camera and a microprocessor configured to compensate the vibration in the output images based on the determined vibration. An orientation of the display corresponds to a direction in which the camera captures the input images. The device and the system may further comprise a housing holding the display and a fixing member configured to fix the housing to a vehicle.

An embodiment of the invention relates to a rear-viewing system providing a stable image and a method to provide a stable image with the rear-viewing system.

When driving a vehicle it is important for safety reasons to be able to recognize what is happening behind the vehicle. “Behind” refers to an area in the opposite direction to a forward driving direction that is determined by a construction of the vehicle.

In vehicles normally rear-viewing mirrors are provided to avoid a need of turning the head of the driver. The rear-viewing mirrors are formed by a reflective surface such that the driver can recognize the image of the surrounding behind the vehicle by looking into the mirror.

However, as shown in FIG. 1 the image of a surrounding 1, which is recognized by a driver 2 by looking into a mirror 3, is very sensitive to an angle variation 4 of the mirror 3 relative to the driver 2 and the surrounding 1. Thus, during driving the vehicle dependent on for example speed and road surface, the mirror image of the rear-viewing mirror looks unstable due to a jittering of the rear-viewing mirror corresponding to angular variation of the position of the rear-viewing mirror 3.

Such a jittering may be caused as well by movements of elements within the vehicle. Such an internal element may be an engine of the vehicle.

It would be beneficial for safety reasons as well as for the comfort of the driver to have a rear-viewing mirror that shows a stable image of the surrounding behind the vehicle.

### BRIEF SUMMARY

It is an object to provide a rear-viewing system and a rear-viewing integrated device for vehicles that provide a stable image of the surrounding behind a vehicle. Further, it is an object to provide a method for displaying a stable image.

These objects are solved by the independent claims.

Further details of embodiments will become apparent from a consideration of the drawings and ensuing description.

### BRIEF DESCRIPTION OF THE SEVERAL VIEWS OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 schematically illustrates the sensitivity of a rear-viewing mirror as it is state of the art to an angular variation.

FIG. 2 schematically illustrates a vehicle to which a rear-viewing system according to an embodiment is attached.

FIG. 3 schematically illustrates a sensitivity of the rear-viewing system when a movement of a display/camera occurs.

FIG. 4 schematically illustrates compensating a vibration by adjusting input data.

FIG. 5 schematically illustrates compensating a vibration by a displacement of a display with respect to a housing.

FIG. 6 schematically illustrates an embodiment of an rear-viewing integrated device with a vibration sensor attached to a display.

FIG. 7 schematically illustrates a further embodiment of an rear-viewing integrated device with a vibration sensor attached to a housing.

FIG. 8 schematically illustrates a further embodiment of an rear-viewing integrated device with a camera.

FIG. 9 schematically illustrates a further embodiment of an rear-viewing integrated device having a camera and a vibration sensor attached to a housing.

FIG. 10 schematically illustrates an output image as a section of an input image.

FIG. 11 shows a block diagram of the rear-viewing system with a single vibration sensor according to a further embodiment.

FIG. 12 shows a block diagram of a rear-viewing system with two vibration sensors according to a further embodiment.

FIG. 13 shows a block diagram of a rear-viewing system comprising a revolution counter according to a further embodiment.

FIG. 14 shows a block diagram of a rear-viewing system having a sun filter according to a further embodiment.

FIG. 15 schematically illustrates a method for displaying a stable image on the display.

FIG. 16 schematically illustrates a method step of compensating the vibration by correcting input data.

FIG. 17 schematically illustrates a method step of compensating the vibration by controlling a position of a display.

FIG. 18 schematically illustrates a further embodiment of a method for displaying a stable image including the compensation for a vibration of the display and the camera.

### DETAILED DESCRIPTION

In the following, embodiments of the invention are described. It is to be noted that all described embodiments in the following may be combined in any way, i.e. there is no limitation that certain described embodiments may not be combined with others. Further, it should be noted that same reference signs throughout the figures denote same or similar elements.

It is to be understood that other embodiments may be utilised and structural or logical changes may be made without departing from the scope of the invention. The following detailed description, therefore, is not to be taken in a limiting sense, and the scope of the present invention is defined by the appended claims.

It is to be understood that the features of the various embodiments described herein may be combined with each other, unless specifically noted otherwise.

FIG. 2 schematically illustrates a rear-viewing system which is attached to a vehicle 201. The vehicle 201 may be a two-, three- or four-wheeled vehicle, a bicycle, a motorcycle, a car, a truck, or a tractor.

The rear-viewing system comprises a camera 202 configured to capture input images, a display 203 configured to display output images based on the input images, at least one vibration sensor 205a and/or 205b configured to determine a vibration of the display and/or the camera, and a microprocessor 204 configured to compensate the vibration in the output images based on the determined vibration. The rear-viewing system may further comprise a housing 206 holding the display and a fixing member 207 configured to fix the housing 206 to the vehicle 201. The housing may comprise or consist of a case.

In the rear-viewing system the camera 202, the display 203, the sensor(s) 205a, 205b and the microprocessor 204 may be connected by signal transmission means 208, 209.

The positioning of components of the rear-viewing system with respect to each other may be varied in accordance with the respective application in the rear-viewing system.

All, some, or at least two of the components (e.g. camera, display, housing, fixing member, vibration sensor, microprocessor) of the rear-viewing system may as well be integrated in an integrated device forming together with the non-integrated components a rear-viewing integrated device. For example, if the camera, the display, the housing, and the fixing member form an integrated device (which may also be referred to as a “compact unit”), the vibration sensor and microprocessor may be referred to as “non-integrated” components. In this example, the integrated device (the display, the housing, and the fixing member) may be attached to the vehicle at a position such that the user may use it as a rear-viewing device, whereas the non-integrated components (vibration sensor and microprocessor) may be located elsewhere. Thus, a distributed system may be achieved. This may have some advantages since e.g. some components of the system, such as e.g. the microprocessor and/or sensor may be located at suitable positions in the vehicle, e.g. in a protected area. Moreover, e.g. the microprocessor could be used for other functions of the vehicle. The microprocessor may be the “board computer” of the vehicle.

The positioning of the camera 202 may be at the rear side of the vehicle 201 as shown in FIG. 2. In other embodiments of the system the camera 202 may be positioned elsewhere at other suitable positions at the vehicle 201. Positions of the camera 202 may be at the license plate, at any side of the vehicle, or for an open vehicle at a handling bar of the motorcycle, or for a car, a truck, and a tractor in the inside of the vehicle 201.

An orientation of the display 203 may correspond to a direction in which the camera 202 captures the input images. Thus, a display direction of the display 203 and a sensing (image capturing) direction of the camera 202 may lie within an angle a of +π/2 rad≧a≧π/2 rad.

Such a rear-viewing system allows a user to display the output images such that a viewer experiences an essentially jitter-free image of the surrounding behind the vehicle.

There are many sources for jittering. Such sources may be an engine 210 of the vehicle 201 or a rough surface 211 on which the vehicle 201 is driving. A vibration generated by these sources may then be transmitted over the structure of the vehicle 201 to the camera 202 and/or the display 203. Therefore, the positioning of the at least one vibration sensor 205a, 205b may be selected based on various aspects. These aspects may be a position where the vibration to be compensated may be determined very precisely, the design of the vehicle 201, or legal restrictions for the positioning. Consequently, the vibration sensor 205b that is configured to determine a vibration of the display 203 may be positioned elsewhere than the vibration sensor 205a that is configured to determine a vibration of the camera 202.

A precise compensation may be achieved by positioning the vibration sensors 205a and/or 205b vibration-free with respect to the element, i.e. the camera 202 or the display 203 for which the vibration sensors 205a and/or 205b determine the vibration.

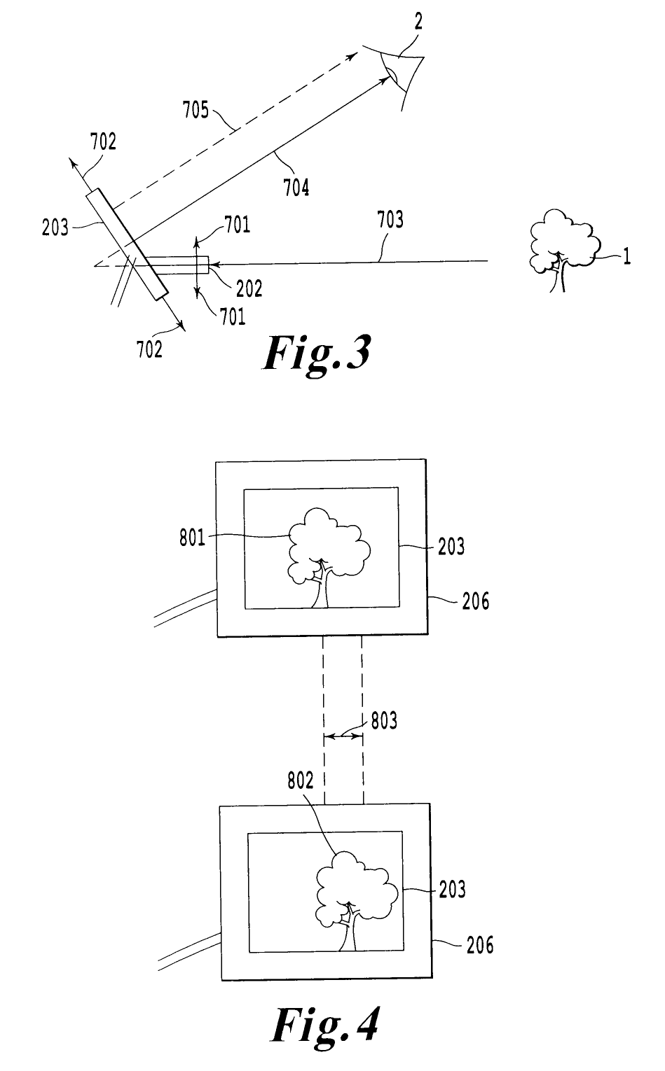

FIG. 3 schematically illustrates exemplary movements 701, 702, corresponding to vibrations of the camera 202 and the display 203, which may be determined and which may be compensated for obtaining a stable image with the rear-viewing system. By the movement 701 of the camera 202 in a plane vertical to a direction of the incident light 703 the light is recorded by a pixel in the camera 202 different than the recording pixel prior to the movement 701. Consequently a different light-emitting element of the display 203 is emitting the light corresponding to the incident light 703. This causes a jittering of the output images as it is recognized by the user's eye 2. Accordingly, if the display 203 is moving 702 in a direction perpendicular to a light-emitting plane of the display 203 the user 2 recognizes jittering output images.

The display 203 in any one of the embodiments may be a liquid crystal display.

The microprocessor 204 of the rear-viewing system may be configured to compensate the determined vibration by adjusting input data corresponding to the input images based on the determined vibration.

FIG. 4 schematically illustrates an embodiment of such compensation by adjusting or modifying or processing input data corresponding to the input images based on the determined vibration. On the display 203 a surrounding may be displayed as an output image 801. Upon movement of the display 203 the output image with respect to a user would be displaced. Under the assumption that the displacement corresponds to a lateral movement 803 the user would recognize the same output image displaced by a distance 803. By determining this displacement 803 with a vibration sensor a compensation algorithm may be used in the microprocessor which recalculates based on the input data and the displacement 803 a new output image 802, so that the output image 801 prior to the displacement of the display 203 coincides with new output image 802 after the displacement 803. Thus, a stable image is obtained.

This compensation may as well be applied to a movement of a camera. By recalculating the output image 802 using the compensation algorithm the movement may be compensated. Thus, a stable output image may be obtained.

Further, other compensation algorithms may be applied.

In any of the embodiments, the movements of the display 203 or the camera 204 which may be compensated may refer to a vibration of the display 203 or the camera 204.

Further, the compensation is not limited to any specific vibration or vibration direction of the display 203 or the camera 204.

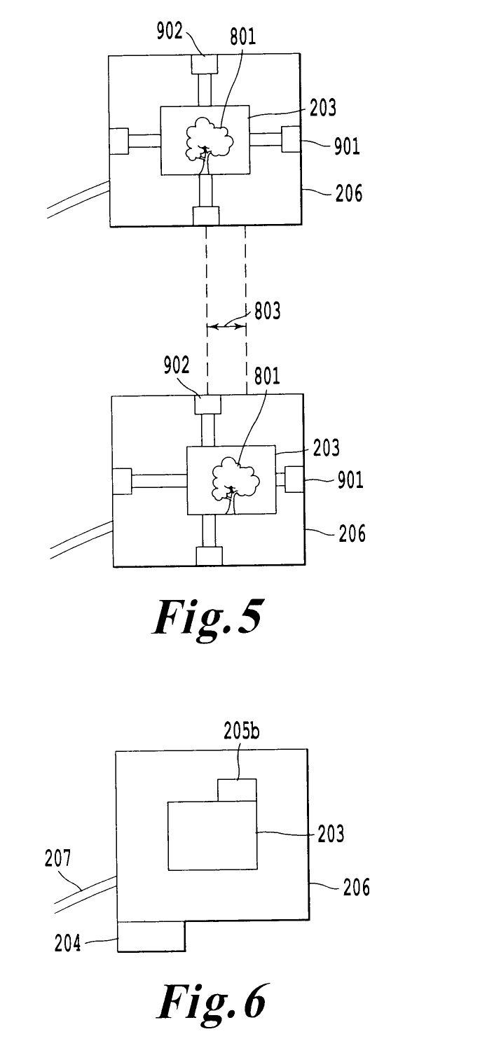

FIG. 5 schematically illustrates compensation by a mechanical compensation component, e.g. driving means 901, 902 such a piezo-element or a servomechanism.

According to this embodiment, the rear-viewing system comprises a driving means 901, 902 configured to adjust the position of the display 203 relative to the housing 206. Further, the microprocessor is configured to control the position of the display 203 by the driving means 901, 902 and to compensate the determined vibration by adjusting the position of the display 203 based on the determined vibration. The mechanical compensation means may be integrated in the integrated device.

Compensating according to the embodiment as shown in FIG. 5 differs from the compensating according to the embodiment in FIG. 4 in that not or not only the input data are manipulated based on the determined vibration to adjust a positioning of the scene on the display 203, but that the display 203 is displaced based on the determined vibration or displacement 803.

The driving means 901, 902 may be configured to displace the display 203 in at least one direction. Further the driving means may as well be configured to amend or adjust the position of the display 203 in a display plane or any direction. Further, the driving means may be configured to rotate the display 203.

Thus, the microprocessor 204 may be configured to modify or set the position of the display 203.

Compensating by means of adjusting input data may be combined with compensating by means of mechanical compensation. Such a combination may allow for a further refinement of compensating the vibration of the display 203 and/or the camera 202. Further, the compensation process may be accelerated with this combination.

FIGS. 6 to 9 schematically illustrate different embodiments how components of the rear-viewing system may be integrated in an integrated device. Other components necessary to provide a stable image may be as well integrated in these devices or may be positioned externally so that the components, which are integrated in the integrated device, are configured to function with these external components to provide a jitter-free image as described above in connection to the rear-viewing system.

FIG. 6 shows an embodiment of the integrated device comprising a display 203 held by a housing 206. Further, a vibration sensor 205b is attached to the display 203. The vibration sensor 205b may be configured to determine a vibration of the display 203. An attachment of the vibration sensor 205b to the display 203 may be vibration-free. This allows a precise determination of a vibration corresponding to the vibration of the display 203.

Further, this integrated device may include a microprocessor 204.

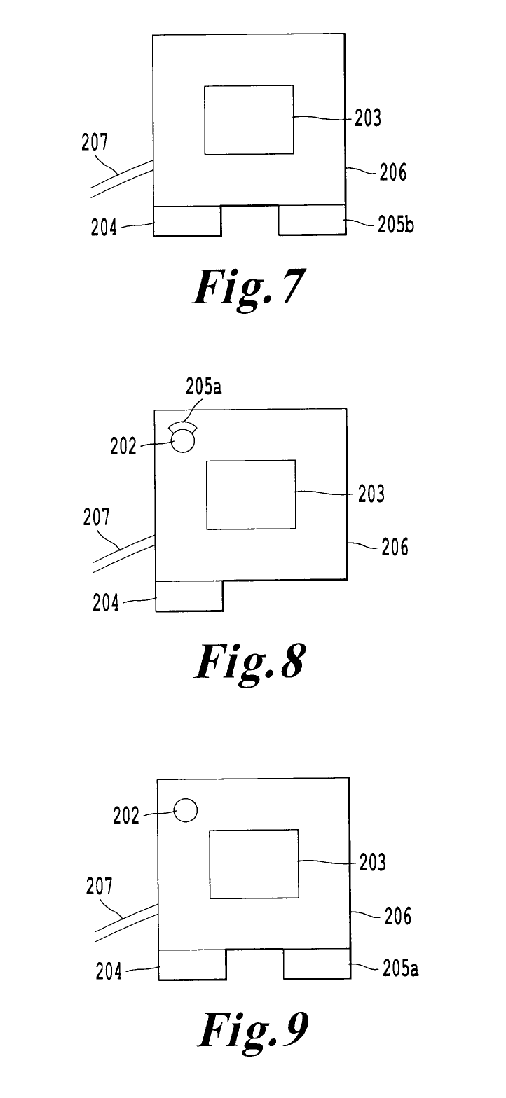

The embodiment of an integrated device as schematically shown in FIG. 7 differs from the integrated device as schematically shown in FIG. 6 in that the vibration sensor 205b is attached to the housing 206. The display 203 may be mounted vibration-free with respect to the housing 206 and the vibration sensor 205b may be mounted vibration-free with respect to the housing. This has the effect that a movement of the display 203 may be precisely determined by the vibration sensor 205b.

FIG. 8 schematically illustrates a further embodiment of the integrated device. It differs from the integrated device as shown in FIGS. 6 and 7 in that the integrated device comprises a camera 202 and a vibration sensor 205a configured to determine a vibration of the camera 202. The vibration sensor 205a may be mounted vibration-free with respect to the camera 202. The vibration sensor 205b as it is present in the embodiments as shown in FIGS. 6 and 7 may be present or not present.

A further embodiment of the integrated device as schematically shown in FIG. 9 differs from the integrated device as shown in FIG. 8 in that the vibration sensor 205a is attached to the housing 206.

The different embodiments according to FIG. 6 to FIG. 9 of an integrated device may be combined in further embodiments of integrated devices.

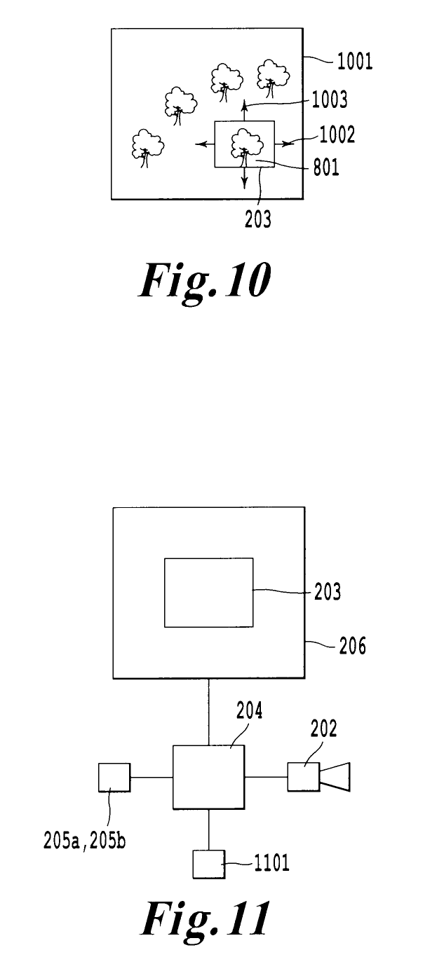

As it is schematically illustrated in FIG. 10, the display 203 may be configured to display as output image 801 only a portion of the input image 1001 captured by the camera. This may have the advantages as will be apparent from the following:

First, the user may adjust which portion of the input image 1001 may be displayed as output image 801, e.g. via a suitable user interface (indicated by the arrows 1002 and 1003 in FIG. 10). This way, it may not be necessary to adjust the camera at all and the camera may be at a constant fixed position/angle.

Second, blank pixels at the side of the output image 801 (or the display) may be avoided which could occur if the size of the output image 801 corresponded one-to-one to the size of the input image 1001. Such blank pixels would for example occur due to compensation of the vibration (jitter) since a compensation algorithm might shift pixels of the input picture with respect to the addressed pixels of display. Therefore, if the size of the output image 801 corresponded one-to-one to the size of the input image 1001 such a compensation algorithm would have to maintain pixels blank.

FIGS. 11 to 14 show block diagrams of different embodiments of the rear-viewing system. All, some or at least one of the additionally included components of the rear-viewing system as they are described referring to FIGS. 11 to 14 may as well be integrated in integrated devices.

FIG. 11 shows a block diagram of an embodiment of a rear-viewing system corresponding to the embodiment shown in FIG. 2. The embodiment as shown in FIG. 11 may further comprise a user interface 1101. The user interface 1101 may be used by a user to adjust an orientation of the display relative to the direction in which the camera captures the input image. Accordingly, in any of the embodiments the display may have means to adjust the direction in which the camera captures the input image relative to display direction. Further, the user interface may be used to select a zoom factor of the camera or a magnification factor on the display.

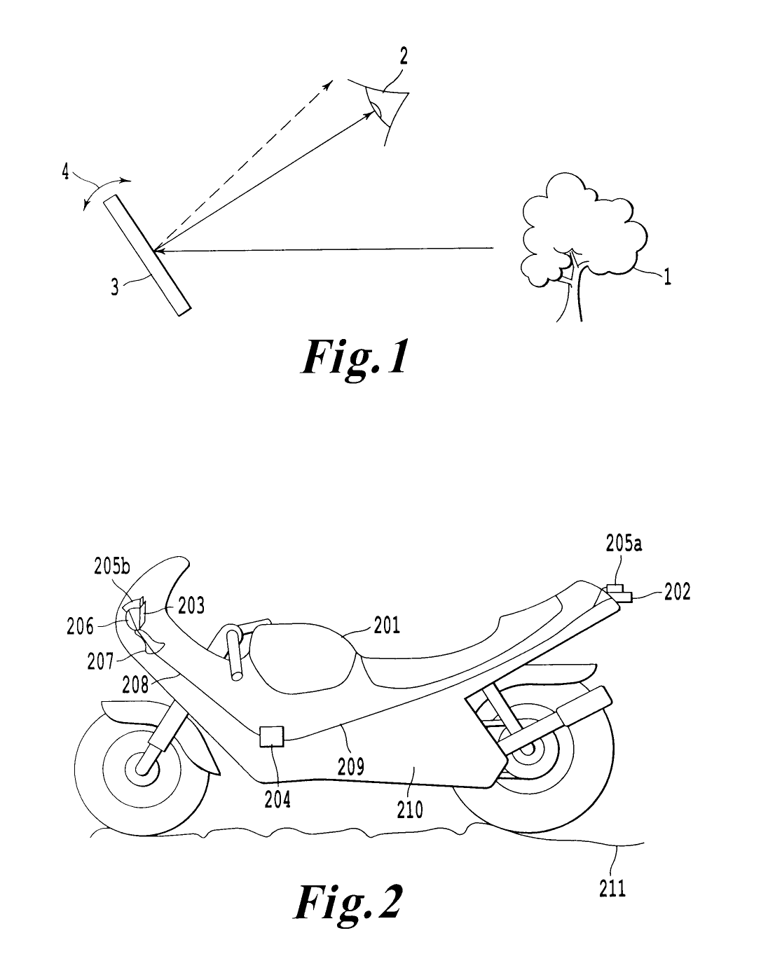

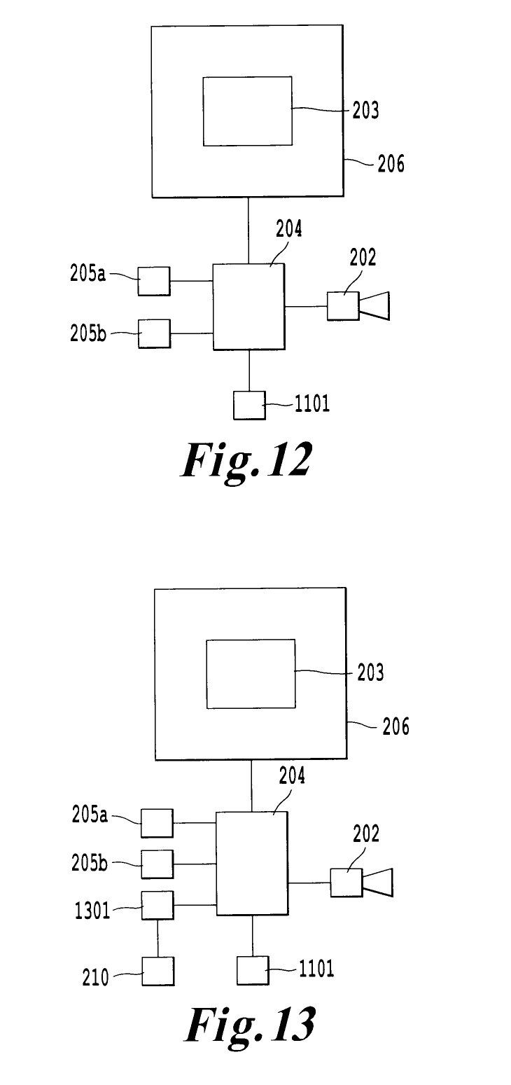

The embodiment as shown in the block diagram in FIG. 12 differs from the embodiment as shown in FIG. 1 in that the rear-viewing system comprises a vibration sensor 205a configured to determine a vibration of the display 203 and a further vibration sensor 205b configured to determine a further vibration of the camera 202. The microprocessor 204 may be configured to compensate a relative vibration of the camera 202 in the output image based on the determined vibration of the display 203 by the vibration sensor 205a and based on the determined further vibration of the camera 202 by the further vibration sensor 205b. Therefore, a rear-viewing system according to the embodiment shown in FIG. 12 is configured to compensate the vibration of the display 203 and the vibration of the camera 202.

It should be noted that compensating the vibration of the camera and the relative vibration of the display with respect to the camera may be equivalent to compensating the vibration of the display and the relative vibration of the camera to the display.

The embodiment as shown in FIG. 13 differs from the embodiment as shown in FIG. 12 in that the rear-viewing system may comprise an engine-speed sensor 1301 configured to determine an engine speed and the microprocessor 204 may be further configured to compensate the vibration based on the determined engine speed.

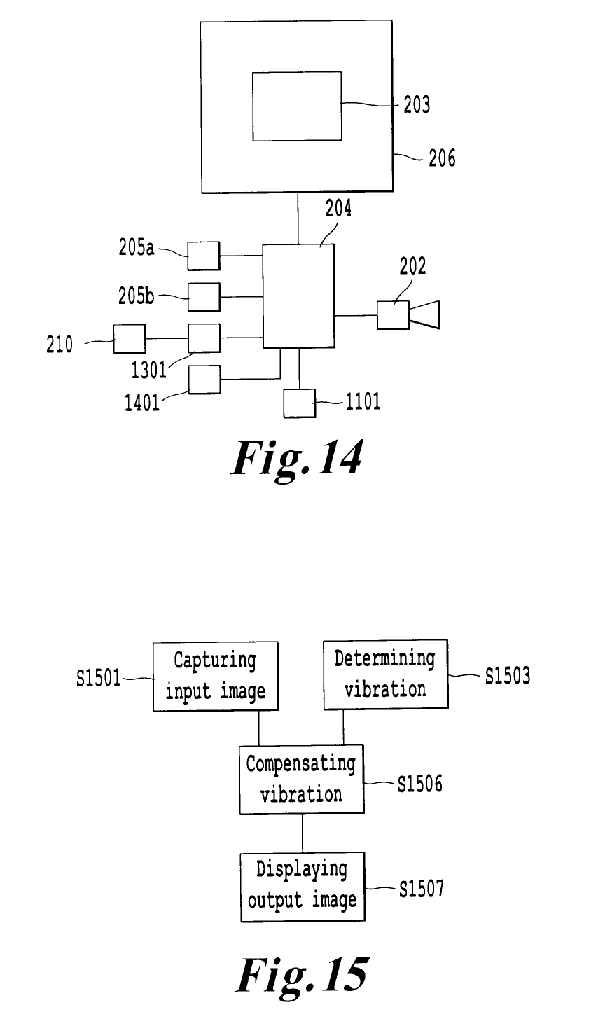

The embodiment as shown in FIG. 14 differs from the embodiment as shown in FIG. 13 in that the rear-viewing system may further comprise a sun filter 1401 configured to adjust the output image based on the sun light intensity and/or sun light wavelength spectrum. This sun filter 1401 may be an electronic sun filter.

A rear-viewing system as it has been described referring to FIG. 1 to FIG. 14 may be used as a mirror of a vehicle.

FIG. 15 schematically illustrates a method for displaying comprising the steps of capturing S1501 input images by a camera, the input images being images of a surrounding behind the vehicle, and of determining S1503, by using a vibration sensor, a vibration of the display and/or of the camera and compensating S1505, by using a microprocessor, the determined vibration in output images. Further, the method comprises displaying S1507 in a display the output images based on the input images, wherein an orientation of the display corresponds to a direction in which the camera captures the input images.

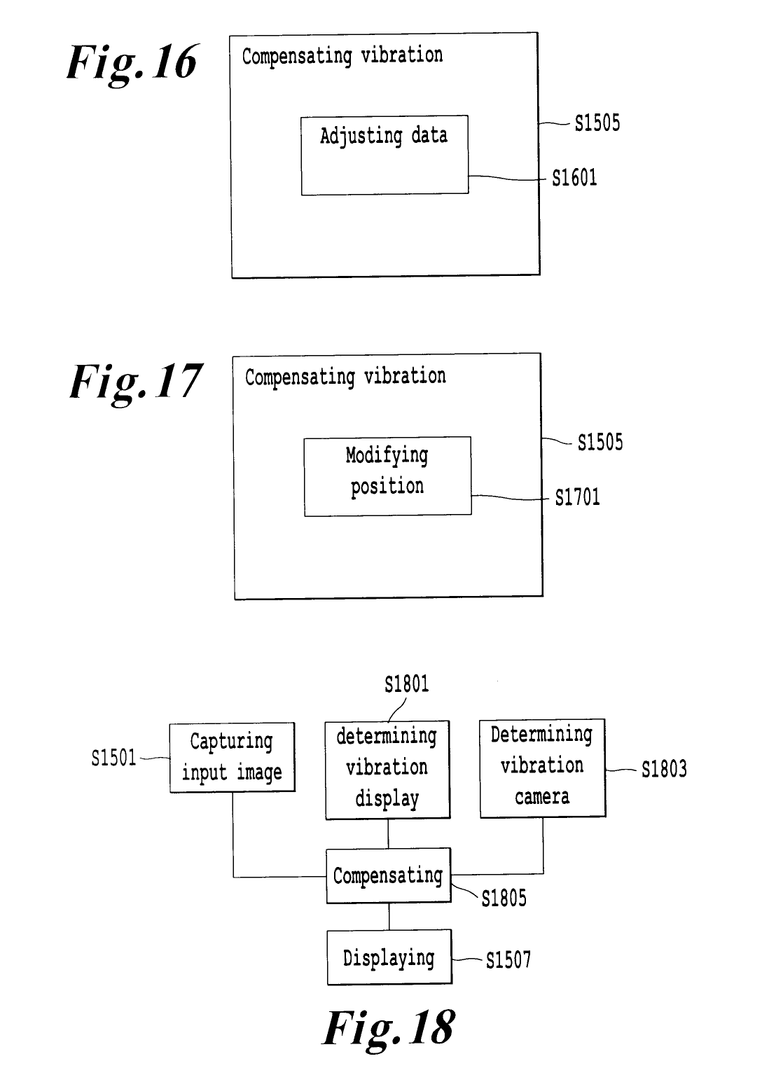

In FIG. 16 it is schematically illustrated that the step of compensating the vibration S1505 may include adjusting S1601 input data corresponding to the input images based on the determined vibration.

In FIG. 17 it is schematically illustrated that the step of compensating S1505 the vibration may include modifying S1701 the position of the display relative to a housing holding the display based on the determined vibration.

According to a further embodiment of the method for displaying, which is schematically illustrated in FIG. 18, the step of determining a vibration S1503 as it is described in connection with FIG. 15 is a step of determining S1801 the vibration of the display. Further, a vibration of the camera may be determined S1803 by a further vibration sensor. The step of compensating S1805 may include additionally to the step of compensating S1505 as it is described referring to FIGS. 15 to 17 compensating a relative vibration of the camera in the output image based on the determined vibration of the display by the vibration sensor and on the determined further vibration of the camera by the further vibration sensor.

Further, the method for displaying may comprise compensating the determined vibration by adjusting or modifying or processing input data corresponding to the input images based on the determined vibration.

Further, the method for displaying may comprise compensating the determined vibration by adjusting the position of the display relative to a housing holding the display based on the determined vibration.

The method as described referring to FIG. 15 to FIG. 18 may be applied to any of the rear-viewing systems as described referring to FIG. 1 to FIG. 14.

1. A rear-viewing system device for vehicles comprising
a camera configured to capture input images;
a display configured to display output images based on the input images;
a housing holding the display;
a fixing member configured to fix the housing to a vehicle;
a vibration sensor configured to determine a vibration of the display and/or the camera; and
a microprocessor configured to compensate the vibration in the output images based on the determined vibration; wherein
an orientation of the display corresponds to a direction in which the camera captures the input images.

2. The rear-viewing system according to claim 1, wherein the fixing member, the housing and the display form a compact unit, and wherein at least one of the camera, the vibration sensor, and the microprocessor are part of the compact unit.

3. The rear-viewing system according to claim 1, wherein
the microprocessor is configured to compensate the determined vibration by adjusting input data corresponding to the input images based on the determined vibration.

4. The rear-viewing system according to claim 1, further comprising
a driving means configured to adjust the position of the display relative to the housing; wherein
the microprocessor is configured to control the position of the display by the driving means; and
the microprocessor is configured to compensate the determined vibration by adjusting the position of the display based on the determined vibration.

5. The rear-viewing system according to claim 4, wherein the driving means is configured to adjust the position of the display in a display plane.

6. The rear-viewing system according to claim 1, wherein the display and the camera are mounted vibration-freely with respect to each.

7. The rear-viewing system according to claim 1, wherein the camera is held by the housing.

8. The rear-viewing system according to claim 1, comprising
a further vibration sensor configured to determine a further vibration of the camera; wherein
the vibration sensor is configured to determine a vibration of the display; and
the microprocessor is configured to compensate a relative vibration of the camera in the output image based on the determined vibration of the display by the vibration sensor and based on the determined further vibration of the camera by the further vibration sensor.

9. The rear-viewing system according to claim 1, wherein the display is configured to display as output image only a portion of the input image.

10. The rear-viewing system according to claim 1, wherein the orientation of the display is adjustable relative to the direction in which the camera captures the input images.

11. The rear-viewing system according to claim 1, further comprising
an engine-speed sensor configured to determine an engine speed, wherein
the microprocessor is further configured to compensate the vibration based on the determined engine speed.

12. The rear-viewing system according to claim 1, further comprising
an electronic sun filter configured to adjust the output image based on the sunlight intensity and/or sunlight wavelength spectrum.

13. Use of the rear-viewing system according to claim 1 as a rear view mirror of a vehicle.

14. A method for displaying comprising
capturing input images by a camera, the input images being images of a surrounding behind a vehicle;
displaying in a display output images based on the input images;
determining, by using a vibration sensor, a vibration of the display and/or of the camera; and
compensating, by using a microprocessor, the determined vibration in the output images; wherein
an orientation of the display corresponds to a direction in which the camera captures the input images.

15. The method for displaying a stable rear view according to claim 14, further comprising
determining a vibration of the display by the vibration sensor;
determining a further vibration of the camera, by using a further vibration sensor; and
wherein compensating the determined vibration includes compensating a relative vibration of the camera in the output image based on the determined vibration of the display by the vibration sensor and on the determined further vibration of the camera by the further vibration sensor.
